(19) United States
(12) Patent Application Publication
(10) Pub. No.: US 2018/0287987 A1
(43) Pub. Date: Oct. 4, 2018

(54) SYSTEM AND METHOD THEREOF FOR CONTEXTUAL CUSTOMIZATION OF NOTIFICATIONS

(71) Applicant: NURO Secure Messaging Ltd., Tel Aviv (IL)

(72) Inventor: Eliyahu PURIAN, Tel Aviv (IL)

(73) Assignee: NURO Secure Messaging Ltd., Tel Aviv (IL)

(21) Appl. No.: 15/938,615

(22) Filed: Mar. 28, 2018

Related U.S. Application Data
(60) Provisional application No. 62/478,071, filed on Mar. 29, 2017.

(51) Int. Cl. H04L 12/58; H04L 29/06; G06F 17/30

(52) U.S. Cl. CPC H04L 51/24; H04L 51/36; G06F 17/30424; H04L 63/20; H04L 63/1425

(57) ABSTRACT

A system and method for contextual customization of notifications sent between end point devices. The method includes receiving from a first end point device a request to send at least one outgoing communication; identifying metadata associated with the request; analyzing the metadata associated with the request to determine a context of request; identifying at least one second end point device as a target to the at least one outgoing communication based on the context; and generating a customized notification to send to each of the at least one identified second end point devices based on the context.

### CROSS-REFERENCE TO RELATED APPLICATIONS

This application claims the benefit of U.S. Provisional Application No. 62/478,071 filed on Mar. 29, 2017, the contents of which are hereby incorporated by reference.

### TECHNICAL FIELD

The present disclosure relates generally to notifications over communication networks, and more specifically to the customization of notifications sent to end point devices within an organizational network.

### BACKGROUND

There has been rapid growth in the number of mobile devices used both within the personal as well as the professional sphere. People use their mobile devices for many purposes that go well-beyond basic cellular telephone communication and include activities such as sending and receiving text and multimedia messages, web browsing, social networking, file collaboration, and much more. As a result of their ubiquity and increasing functionality, mobile devices have become a burgeoning target for malicious activities, especially within an organizational or professional environment, which can contain sensitive and valuable information, both about the organization itself and about others it interacts with, including customers, vendors, and suppliers. As organizations and enterprises grow larger, they become more exposed to potential malicious attacks, such as ransomware, phishing, and hacking attempts, that may be initiated via the multitude of user devices associated with the organization's employees.

Establishing secure network connections between two or more end point devices within an organizational environment is critical when dealing with sensitive information such as data transfers. Enterprises spend significant resources ensuring that secure network communications among their employees proceed in a secure, as well as efficient, manner. Furthermore, large enterprises may have expansive intra-enterprise networks that rely on secure communications between various network devices.

Large scale attacks can include activities that gain unlawful access to electronically stored data and can cause significant damage, both in the data loss itself, as well as the embarrassment and public relations fallout affecting such companies.

While certain communication systems currently exist that are geared toward secure communication within an enterprise environment as a whole, many do not offer a unified communication network between two specific devices within an organization. It would be further advantageous if such a solution allows for the automatic customization of the communication based on at least the context of a communication request itself.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for contextual customization of notifications sent between end point devices, the method including: receiving from a first end point device a request to send at least one outgoing communication; identifying metadata associated with the request; analyzing the metadata associated with the request to determine a context of request; identifying at least one second end point device as a target to the at least one outgoing communication based on the context; and generating a customized notification to send to each of the at least one identified second end point devices based on the context.

Certain embodiments disclosed herein also include a non-transitory computer readable medium having stored thereon instructions for causing a processing circuitry to perform a process, the process including: receiving from a first end point device a request to send at least one outgoing communication; identifying metadata associated with the request; analyzing the metadata associated with the request to determine a context of request; identifying at least one second end point device as a target to the at least one outgoing communication based on the context; and generating a customized notification to send to each of the at least one identified second end point devices based on the context.

Certain embodiments disclosed herein also include a system for contextual customization of notifications sent between end point devices, the system including a processing circuitry; and a memory, the memory containing instructions that, when executed by the processing circuitry, configure the system to: receive from a first end point device a request to send at least one outgoing communication; identify metadata associated with the request; analyze the metadata associated with the request to determine a context of request; identify at least one second end point device as a target to the at least one outgoing communication based on the context; and generate a customized notification to send to each of the at least one identified second end point devices based on the context.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system for contextual customization of notifications sent between end point devices according to an embodiment.

FIG. 2 is a block diagram of the administrator server according to an embodiment.

FIG. 3 is a flowchart of a method for contextual customization of notifications according to an embodiment.

FIG. 4 is a flowchart of a method of generating a customized notification according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for the contextual customization of notifications sent between end point devices according to an embodiment. The system includes a network connected to an administrator server and a communication server as well as to a plurality of end point devices (EPDs) having agents installed locally thereon that are associated with an organization's employees. Upon receiving a request to send a certain communication from a first EPD to a second EPD via a natively installed agent, the request is analyzed by the administrator server and the communication server to determine the type of notification to be sent and to which second EPD to send it to. A notification is generated and customized based on the context and metadata of the content of the request. The notification is then provided to the one or more second end point devices. According to an embodiment, the type of notification may further be customized based on variables associated with the one or more second end point devices as discussed herein below.

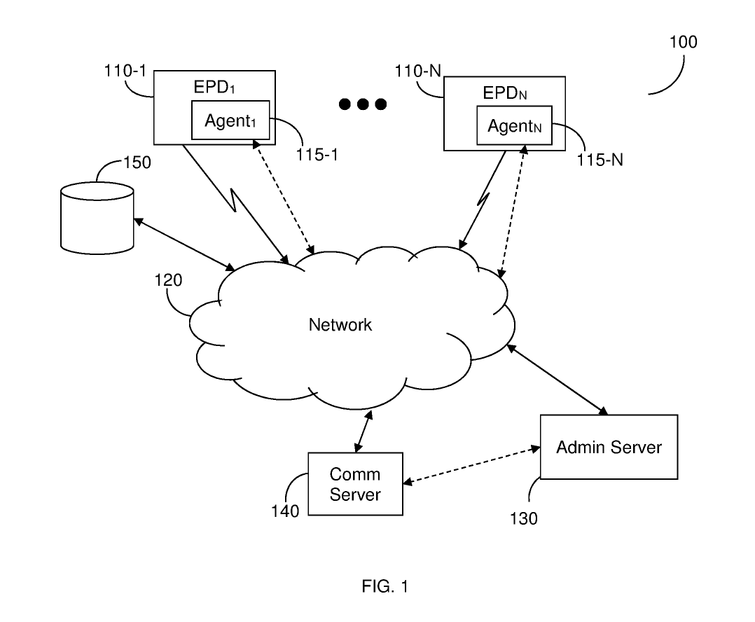

FIG. 1 is a network diagram of a system 100 for contextual customization of notifications sent between end point devices according to an embodiment. The system 100 enables end point devices to communicate with each other in a monitored and secured manner as further described below. The system 100 further enables automatic customization of communication notifications based on the context of the communication.

A plurality of end point devices (EPD) 110-1 through 110-N (collectively referred hereinafter as end point devices (EPDs) 110 or individually as an end point device (EPD) 110, merely for simplicity purposes), where N is an integer equal to or greater than 1, are connected to an enterprise's network 120. The EPDs 110 may be, but are not limited to, smartphones, mobile phones, laptops, tablet computers, personal computers (PCs), wearable computing devices, or any other device capable of sending and receiving communication data.

Each of the EPDs 110-1 through 110-N has an agent installed therein, 115-1 through 115-N respectively (collectively referred hereinafter as agents 115 or individually as an agent 115, merely for simplicity purposes). Each of the agents 115 may be implemented as an application program having instructions that may reside in a memory (not shown) of the respective EPD 110.

The network 120 may include a local area network (LAN), a wide area network (WAN), a metro area network (MAN), the worldwide web (WWW), the Internet, an intranet, as well as a variety of other communication networks, whether wired or wireless, and in any combination, that enable the transfer of data between the different elements of the system 100.

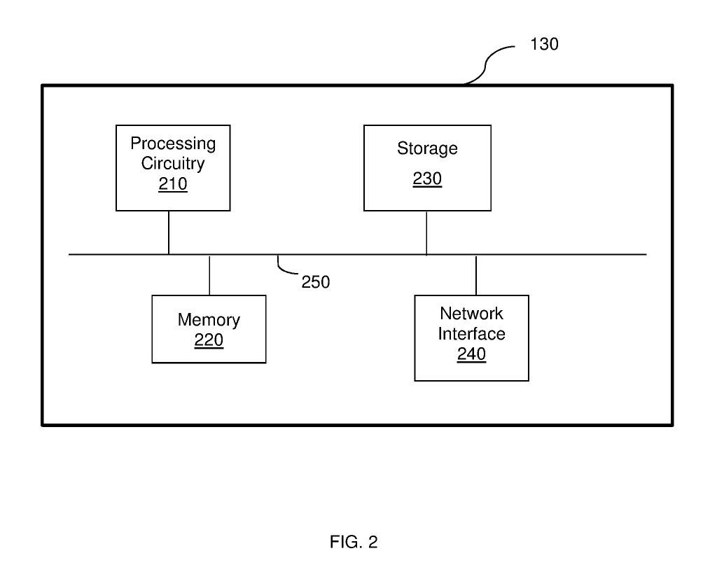

An administrator server 130 is further connected to the network 120. The administrator server 130 is configured to receive and send data or content via the network 120, e.g., between one or more of the EPDs 110. The administrator server 130 includes a memory and processing circuitry as discussed below in FIG. 2 and may be operated by a representative or employee of the organization.

The administrator server 130 is further coupled to a communication server 140. In one embodiment, the administrator server 130 is directly connected to the communication server 140, and in another embodiment the administrator server 130 is connected to the communication server 140 via the network 120. The communication server 140 is configured to receive communication requests from one or more EPDs 110.

The system 100 further includes a database 150. The database 150 is configured to store therein information associated with the organization's security level as received from the administrator server 130 and may change from time to time. For example, the database 150 may include a listing of certain security level clearances that each EPD is assigned, or which EPDs are authorized to communicated with which other EPDs. According to a further embodiment, the database 150 is further configured to store therein validated entities with which the EPDs 110 can securely communicate via the network 120, as further described herein below.

According to the embodiments disclosed herein, the system 100 enables a first EPD, for example, the EPD 110-1, to securely communicate with at least a second EPD. The system 100 automatically determines the optimal display of a notification of the communication on the at least a second EPD based on a determined context of the desired communication.

The operation begins upon receipt of a request, e.g., an outgoing communication request, from a first EPD 110-1 via the respective agent 115-1 by the communication server 140. Upon receiving the request by the communication server 140 for an outgoing communication, the request is analyzed. The analysis may include identification of metadata associated with the communication request. The metadata may be, for example, a type of communication, type of content, the request target, a title, recipient data, instructions received from the first EPD 110-1 related to the request, urgency indicators, a combination thereof, and the like.

The type of communication may be, for example, whether the requested communication is an SMS, an MMS, an email, an instant message, a file share request, and the like. The type of content may include an indication that the message contains only text, only images, both text and images, links to external references, and the like. Recipient data may include, for example, a recipient name, title, department, email address, phone number, username, associated user device or devices, and the like. The identified metadata is then analyzed by the administrator server 130. The analysis may include one or more machine learning techniques, computer vision techniques, artificial intelligence, a combination thereof, and the like. The analysis may include matching the metadata of the request to similar reference metadata, e.g., metadata stored on the database, and determining similar characteristics between the current request and the reference metadata.

According to an embodiment, the analysis of the request may include security validation of the request based on the metadata. The security validation may be performed using one or more anomaly detection tools, data leakage tools, a combination thereof, and the like, to determine if the request is a legitimate request.

Based on the analysis, a context of the request is determined. The context is a computer readable medium representative of the communication content and indicative thereof. The context may be, for example, a topic of the at least one outgoing communication request, a summary of the content of the at least one outgoing communication request, metadata associated with the first EPD 110-1 initiating the request, a combination thereof, and the like. The metadata associated with the first EPD 110-1, may be, for example, device information, a location pointer associated with the request, time of the request, demographic information, a combination thereof, and so on.

Based on the context, one or more second EPDs 110 to which the request is to be sent are identified by the communication server 140. The identification may further be achieved based on querying the database 150 for a set of rules associating between a determined context and certain EPDs 110. The rules may further be enriched over a period of time by the communication server 140 based on previous requests. Subject to the security validation, a record associated with each of the one or more second EPDs is added to the database 150. Such a record constitutes a security validation of the one or more second EPDs as authorized personas with respect to communication with the first EPD.

A notification respective of the request is provided to the one or more second EPDs by the communication server 140. According to an embodiment, the notification may be customized based on the determined context. As a non-limiting example, in case a discrete context is determined, a password protected notification may then be provided to the one or more second EPDs in order to prevent data leakage.

The customization may include determination of a type of the outgoing communication, e.g., an e-mail, an SMS, an MMS, a voice call, a voice message, an instant message, a file share, a combination thereof, and the like. As a non-limiting example, upon receiving a request to send an outgoing email from a first end point device to a corporate compliance manager of the organization, the request is analyzed, and metadata associated thereto is identified.

The metadata may include, for example the content of the request, e.g., text, multimedia, attachments, etc. The communication is then scanned for security validation. Thereafter, a context of the communication is identified. Based on the context, a determination to send an email to an e-mail account identified as associated with the compliance manager of the corporate respective of the context is made.

According to an embodiment, additional variables associated with the delivery of the communication may be generated. Such variables may include, but are not limited to, a time of the sending of the request, urgent indicators (i.e., how urgent the communication is determined to be), additional EPDs designated as recipients, and the like.

Using the aforementioned example, if it has been determined that the compliance manager is currently in a different time zone than the originator of the request where it is nighttime but the communication is identified as urgent, a call may be sent instead of an email in order to draw the compliance manager's attention. Alternatively, in case the communication is identified as not urgent and the compliance manager is identified as currently being in a meeting, an email may be sent to the compliance manager at a later time, when it is determined that the meeting has ended.

FIG. 2 is a block diagram of the administrator server 130 according to an embodiment. The administrator server 130 includes a processing circuitry 210 connected to a memory 220 and a network interface 240 via a bus 250. The processing circuity 210 is configured to receive and send content from one EPD to another over the network and may be further configured to analyze a request to determine metadata associated with the request, and context of the request. The network interface 240 may include, but is not limited to, a wired interface (e.g., an Ethernet port) or a wireless port (e.g., an 802.11 compliant WiFi card) configured to connect to the network 120. The network interface 240 allows the administrator server 130 to communicate with the rest of the system 100, in order to receive requests and send notifications and content. The network interface 240 further allows the detector 160 to communicate with the various networks.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 230 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform an analysis of a received request to determine a notification to be send to an intended recipient device.

In an embodiment, the administrator server 130 may further include a storage 230, where an application configured to analyze a communication request may be stored. The storage 230 may be magnetic storage, optical storage, and the like, and may be realized, in any medium which can be used to store the desired information. The storage 230 may store communication requests associated with one or more EPDs.

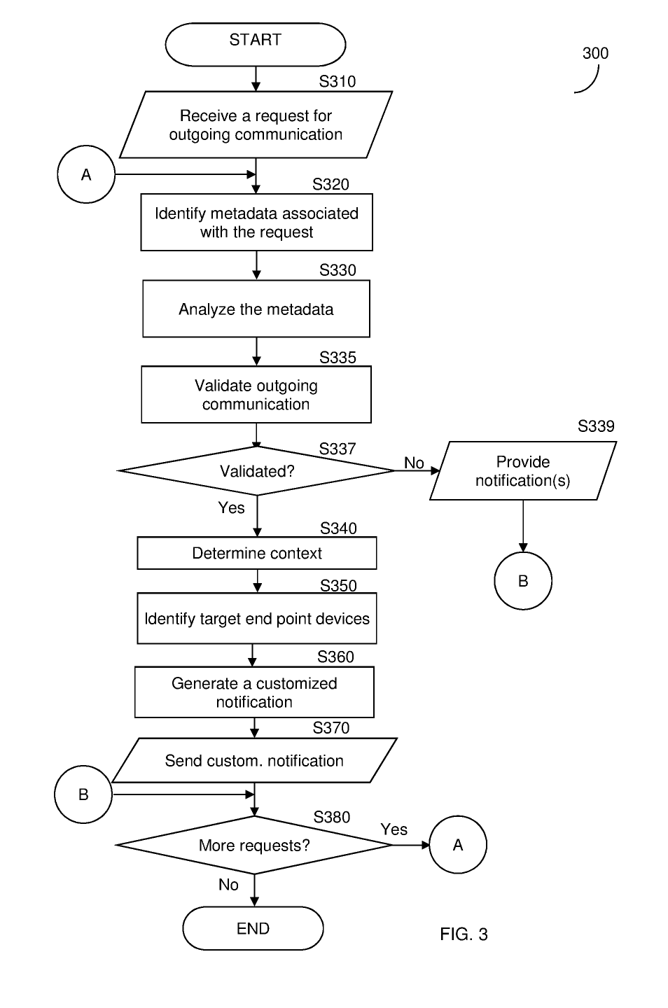

FIG. 3 is a flowchart of a method 300 for securely customizing and delivering communication notifications in an organizational environment according to an embodiment. At S310, the method begins when a request for at least one outgoing communication is received. The request may be sent by an end point device, for example, the EPD 110-1 of FIG. 1 via the respective agent EPD-115-1,and received by the communication server 140.

At S320, metadata associated with the request is identified, e.g., by the administrator server 130. According to an embodiment, the metadata may be identified by the administrator server 130 in conjunction with at least one of: the agent 115-1 and/or the communication server 140.

The metadata may include, for example, a type of communication, a type of content, a request target, a title, recipient data, instructions received from the first EPD 110-1, a combination thereof, and the like. The type of communication may be, for example, an SMS, and MMS, an email, an instant message, a file share, and the like. The type of content may include, text only, image only, text and image, video, and the like. Recipient data may include, for example, recipient name, title, department, email address, phone number, etc.

At S330, the metadata associated with the communication request is analyzed.

According to an embodiment, the analysis may include matching of the metadata to similar metadata and/or metadata associated with the EPD 110-1 extracted from the database 150. According to further embodiment, the metadata may further include one or more machine learning techniques, one or more computer vision techniques, artificial intelligence, a combination thereof, and the like. In yet a further embodiment, the analysis may include applying a set of rules extracted from a database.

At optional S335, a security validation of the outgoing communication request is performed. The validation is performed based on the analysis of the metadata. According to an embodiment, the validation may be performed using one or more anomaly detection tools, one or more data leakage tools, a combination thereof, and the like. The security validation may be executed by the communication server 130.

At S337, it is determined whether the outgoing communication request was validated, and if so, execution continues with S340; otherwise, execution continues with S339. At S339, a notification that the outgoing communication request was not validated is generated by the communication server 140. According to a further embodiment, at S339 the notification is then provided to the administrator server 130, sent for storage in a database, e.g., the database 150 of FIG. 1, for further uses, or sent to the first EPD, and execution continues at S370.

At S340, the context of the request is determined based on the analysis of the metadata. The context is a computer readable medium representative of the communication and indicative thereof. The context may be, for example, a topic of the at least one outgoing communication request, content of the at least one outgoing communication request, metadata associated with the first EPD 110-1, a combination thereof, and the like.

At S350, based on the generated context of the outgoing communication, one or more target devices are identified, e.g., among the EPDs 110. In an embodiment, the context itself identifies a target EPD. In an alternative embodiment, target numbers received as part of the request, e.g., phone numbers and/or emails, may be received along with the request and used to assist in identification of a target EPD.

At S360, a customized notification is generated based on the determined context. The customization is further described herein below with respect of FIG. 3, and may include, but is not limited to, a type of push notification, an email, an SMS message, haptic or audio feedback caused by the receiving device, customized time of sending the message, customized time of notification, whether to show the notification as a pop-up or not, customized visuals, e.g., font size, font color, bold or italics, urgency marking, and the like. At S370, the customized outgoing communication notification is sent to the one or more target point devices.

At S380, it is checked whether additional requests have been received, and if so, execution continues with S320; otherwise, execution terminates.

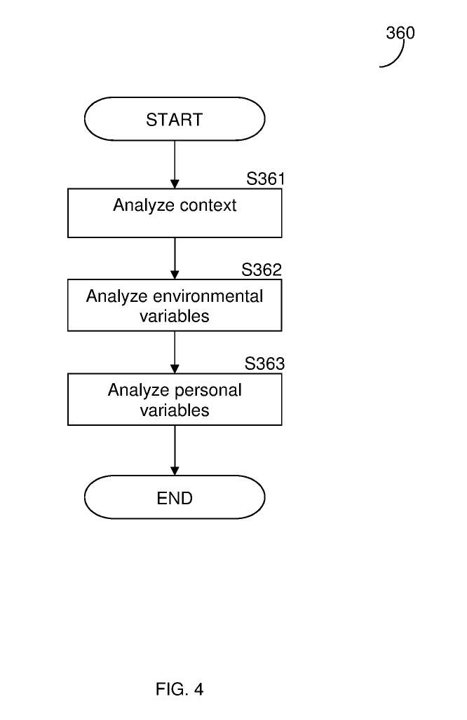

FIG. 4 is a flowchart of a method 400 for customizing communication sent in an organizational environment according to an embodiment. At S361, the context of the received communication request is analyzed as further described hereinabove with respect to FIG. 1.

At S362, environmental variables are identified, where the environmental variable are associated with at least one of: the sending EPD and/or the recipient EPD(s). The environmental variables may include, for example, a time pointer, a location pointer, a network to which the EPD is connected, the last time the EPD has sent or received a message over the network, and the like.

At S363, personal variables are identified, where the personal variable are associated with at least one of: the sending EPD and/or the recipient EPD(s). The personal variables may include, for example, whether or not the device or a user of that device is currently busy, past communication sent to and/or from that device, previous devices which with that device has communicated with, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for contextual customization of notifications sent between end point devices, comprising:
receiving from a first end point device a request to send at least one outgoing communication;
identifying metadata associated with the request;
analyzing the metadata associated with the request to determine a context of request;
identifying at least one second end point device as a target to the at least one outgoing communication based on the context; and
generating a customized notification to send to each of the at least one identified second end point devices based on the context.

2. The method of claim 1, further comprising:
scanning, based on the metadata, the request for security validation of the at least one outgoing communication.

3. The method of claim 2 wherein the security validation is performed using at least one of: an anomaly detection security tool and a data leakage tool.

4. The method of claim 1, wherein the at least one outgoing communication is at least one of: an e-mail, instant messaging, text message, multimedia message, voice call, video message, voice over internet protocol (VOIP) call, voice message, and file share.

5. The method of claim 1, wherein the analyzing the metadata includes matching the metadata to similar metadata associated with an end point device.

6. The method of claim 5, wherein the context is at least one of: a topic of the at least one outgoing communication, summary of the content of the at least one outgoing communication, and metadata associated with the first end point device.

7. The method of claim 6, wherein the metadata is at least one of: a type of communication, a type of content, a request target, a title, recipient data, and instructions received from the end point device.

8. The method of claim 1, wherein identifying the at least one second end point device further comprises:
querying a database for a set of rules associating between a determined context and certain end point devices.

9. The method of claim 1, wherein the notification is customized based on at least one of: the context, at least one environmental variable, and at least one personal variable.

10. The method of claim 1, wherein the customized notification includes at least one of: a type of push notification, an email, an SMS message, haptic or audio feedback caused by the receiving device, customized time of sending the message, customized time of notification, whether to show the notification as a pop-up or not, customized notification visuals, and urgency markings.

11. A non-transitory computer readable medium having stored thereon instructions for causing a processing circuitry to perform a process, the process comprising:
receiving from a first end point device a request to send at least one outgoing communication;
identifying metadata associated with the request;
analyzing the metadata associated with the request to determine a context of request;
identifying at least one second end point device as a target to the at least one outgoing communication based on the context; and
generating a customized notification to send to each of the at least one identified second end point devices based on the context.

12. A system for contextual customization of notifications sent between end point devices, the system comprising:
a processing circuitry; and
a memory, the memory containing instructions that, when executed by the processing circuitry, configure the system to
receive from a first end point device a request to send at least one outgoing communication;
identify metadata associated with the request;
analyze the metadata associated with the request to determine a context of request;
identify at least one second end point device as a target to the at least one outgoing communication based on the context; and
generate a customized notification to send to each of the at least one identified second end point devices based on the context.

13. The system of claim 12, wherein the system is further configured to:
scan, based on the metadata, the request for security validation of the at least one outgoing communication.

14. The system of claim 13 wherein the security validation is performed using at least one of: an anomaly detection security tool and a data leakage tool.

15. The system of claim 12, wherein the at least one outgoing communication is at least one of: an e-mail, instant messaging, text message, multimedia message, voice call, video message, voice over internet protocol (VOIP) call, voice message, and file share.

16. The system of claim 12, wherein system is further configured to match the metadata to similar metadata associated with an end point device.

17. The system of claim 16, wherein the context is at least one of: a topic of the at least one outgoing communication, summary of the content of the at least one outgoing communication, and metadata associated with the first end point device.

18. The system of claim 17, wherein the metadata is at least one of: a type of communication, a type of content, a request target, a title, recipient data, and instructions received from the end point device.

19. The system of claim 12, wherein system is further configured to:
query a database for a set of rules associating between a determined context and certain end point devices.

20. The system of claim 12, wherein the notification is customized based on at least one of: the context, at least one environmental variable, and at least one personal variable.

21. The system of claim 12, wherein the customized notification includes at least one of: a type of push notification, an email, an SMS message, haptic or audio feedback caused by the receiving device, customized time of sending the message, customized time of notification, whether to show the notification as a pop-up or not, customized notification visuals, and urgency markings.
